(19) United States
(12) Patent Application Publication
(10) Pub. No.: US 2024/0342765 A1
(43) Pub. Date: Oct. 17, 2024

(54) Systems and Methods for Clearing Build-Up From Conduits

(71) Applicant: Salamander IP Holdings LLC, Hamilton (BM)

(72) Inventors: Robert Michael RAINEY, Cypress, TX (US); Amanda KHAN, Houston, TX (US)

(21) Appl. No.: 18/632,391

(22) Filed: Apr. 11, 2024

Related U.S. Application Data
(60) Provisional application No. 63/495,577, filed on Apr. 12, 2023.

(51) Int. Cl. B08B 9/032

(52) U.S. Cl. CPC B08B 9/032

(57) ABSTRACT

Systems and methods for removing buildup from a subsea pipeline are described herein. A buildup removal system comprises a conduit for transporting contents, wherein the conduit comprises a lower portion and a riser portion. In the system, a heating mechanism is configured to apply heat to a section of the lower portion and generate heated contents within the conduit, and the heated contents comprise a temperature that removes buildup from sidewalls of the riser portion.

### CROSS-REFERENCE TO RELATED APPLICATIONS

This application claims priority to U.S. Provisional Application No. 63/495,577, filed Apr. 12, 2023, which is incorporated herein by reference in its entirety.

### TECHNICAL FIELD

The present disclosure relates to systems and methods for removing buildup from conduits for fluid and/or gas transport.

### BACKGROUND

In certain systems for transporting materials, conduits, such as pipelines, may be used for long-distance transportation of a liquid and/or gas. For example, pipelines (e.g., flowlines) can be used to transport materials such as crude oil, natural gas, and/or water from a reservoir to a location for processing. These pipelines may develop buildup, such as a wax or hydrate formation, that restricts flow through the conduit. Embodiments described herein may provide solutions for removing such buildup.

### SUMMARY

In one aspect, a buildup removal system is provided including a conduit for transporting contents, wherein the conduit comprises a lower portion and a riser portion. The buildup removal system includes a heating mechanism configured to apply heat to a section of the lower portion and generate heated contents within the conduit. The heated contents comprise a temperature that removes buildup from sidewalls of the riser portion.

According to an embodiment, the conduit comprises a subsea pipeline, the contents comprise crude oil, natural gas, and/or water, and the lower portion is disposed along a seafloor. The system further comprises a subsea manifold configured to supply the contents to the lower portion of the subsea pipeline and an offshore platform configured to receive the contents from the riser portion of the subsea pipeline.

According to an embodiment, the buildup comprises at least one of a wax buildup and a hydrate buildup.

In accordance with an embodiment, the heating mechanism comprises one of a temporary heater or a permanently installed heater.

According to an embodiment, the riser portion comprises an upper portion and an intermediate portion; and the buildup is disposed on sidewalls of the intermediate portion of the riser.

In accordance with an embodiment, the heating mechanism is configured to supply heat to the contents such that the temperature of the heated contents is greater than 6.5 times a temperature of the contents without the heating mechanism.

In another aspect, a method of clearing buildup from a conduit comprising a lower portion and a riser portion comprises applying heat to a section of the lower portion to generate heated contents within the section of the lower portion of the conduit, and flowing the heated contents into the riser portion such that the heated contents remove buildup from sidewalls of the riser portion.

According to an embodiment, the heat is applied via a heating mechanism comprising one of a temporary heater or a permanently installed heater.

In accordance with another embodiment, the method further comprises continuing a flow the through the conduit at a constrained rate.

According to an embodiment, prior to applying heat, a flow through the conduit is restricted.

In accordance with an embodiment, the conduit comprises a subsea pipeline and the buildup comprises wax and/or hydrate buildup.

According to an embodiment, the lower portion is disposed along a seafloor and configured to receive input contents from a subsea manifold, and the input contents comprise crude oil, natural gas, and/or water. Additionally, applying the heat to the section of the lower portion generates the heated contents from the input contents.

In accordance with a further embodiment, the input contents comprise a first temperature and the heated contents comprise a second temperature that is 6.5 times or more greater than the first temperature.

In accordance with a further embodiment, the riser portion is configured to supply the heated contents to an offshore platform.

In accordance with a further embodiment, the offshore platform is configured to divide the heated contents into separate quantities of crude oil, natural gas, and water

In yet another aspect, a subsea oil and gas system comprises an offshore platform, a subsea manifold, a first subsea pipeline comprising a horizontal lower portion disposed along a seafloor and a riser portion extending vertically from the horizontal lower portion, and a heating mechanism. The offshore platform is configured to receive contents from the first subsea pipeline, wherein the contents comprise crude oil, natural gas, and water. The offshore platform is further configured to divide the contents into separate quantities of crude oil, natural gas, and water, and to export the separate quantities to land via a second subsea pipeline. The subsea manifold is configured to receive the contents from a third subsea pipeline and supply the contents to the horizontal lower portion of the first subsea pipeline. The heating mechanism is configured to apply heat to the contents within the first subsea pipeline such that the contents remove a buildup from sidewalls of the riser portion.

According to an embodiment, the buildup comprises a wax and/or hydrate buildup.

### BRIEF DESCRIPTION OF THE DRAWINGS

Aspects of the present disclosure are best understood from the following detailed description when read with the accompanying figures.

FIG. 1 depicts a subsea oil and gas system, in accordance with some embodiments.

FIG. 2 depicts an example system for clearing buildup from a conduit, in accordance with some embodiments.

FIGS. 3A, 3B, and 3C depict stages of a method for clearing buildup from a conduit, in accordance with some embodiments.

FIG. 4 depicts a flowchart of a method for clearing buildup from a conduit, in accordance with some embodiments.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one with skill in the art upon examination of the detailed description. It is intended that all such additional systems, methods, features, and advantages be included within this description, be within the scope of the present invention.

As described above, pipelines, such as flowlines, can be used to transport crude oil, natural gas, and/or water between locations. For example, a pipeline or flowline may transport these materials from an oil or natural gas reservoir, such as an oil well, to a location where the materials can be divided and then further exported for processing. Due to environmental conditions, buildup, such as a wax or hydrate formation, may form within these pipelines or flowlines. In embodiments described herein, heat may be applied to these pipelines or flowlines in order to reduce the presence of such buildup.

In particular, riser portions of a pipeline (i.e., portions that are inclined or otherwise extend vertically), are at risk of developing buildup because these portions are often difficult to heat. Embodiments herein address this issue by providing systems and methods for reducing buildup in these sections of a conduit.

In a particular scenario, crude oil and natural gas may be located in reservoirs beneath a seafloor. Subsea oil wells can be used to drill and extract the contents of these reservoirs. To process the contents of these reservoirs, pipelines, such as flowlines, may be used to transport crude oil, natural gas, and water from a subsea oil well to an offshore platform, where it can be divided into separate quantities of crude oil, natural gas, and water. The crude oil and natural gas may then be shipped to land through export pipelines to locations where they can be processed and subsequently used in various products (e.g., gasoline). As used here, “subsea pipelines” may refer to any conduits or flowlines used to transport the contents of a subsea reservoir to an offshore platform, as well as the export pipelines used to transport the crude oil and natural gas to land, and also any other pipeline, flowline, or conduit used to transport subsea substances.

In subsea systems, buildup such as hydrate or wax formations may form within such subsea pipelines. This buildup may form, for example, due to a relatively cold seawater temperature (e.g., approximately 4 degrees Celsius). The buildup, for example hydrate or wax formations, may impede the flow of crude oil, natural gas, or other substance within the subsea pipelines. As described above, heat may be applied to the subsea pipelines to reduce the presence of buildup such as hydrate and wax formations.

One issue that may arise with respect to deep water flowlines is plugging in the riser section of a flowline. In subsea pipeline systems with deep water flowlines, the riser section is the section extending from the seafloor to the platform. Plugging in the riser section may be caused by a buildup of, for example a waxy deposition and/or hydrate deposition. In certain scenarios, the buildup may comprise asphaltene build up. This buildup may be difficult to address because operators may be hesitant to penetrate the pressure containment of the flowline riser to put heaters inside of the flowline, and the flowline risers may include insulation and vortex shedding devices mounted on the outside of the flowline, such that it is also difficult to address the plugging problem by heating the outside of the flowline riser.

In subsea systems, the lower riser section may be where the lowest temperature occurs where the fluids in a flowline have a lowest temperature because (1) the fluid has cooled coming through the flowline length, and (2) fluid moving up through the riser has a lower hydrostatic pressure. This pressure drop may allow gas to expand and drop in temperature through Joule-Thompson cooling. Due to the low temperature of this region, the lower riser section may be a problem spot for wax or other buildup. In certain instances, very flexible tubes may be inserted down the riser in order to jet clear out such buildup. However, this may entail pumping and returning potentially hazardous chemicals for wax removal and Xylene and/or Toluene to remove asphaltenes. Embodiments described herein provide systems and methods for removing buildup in a flowline without having to penetrate the pressure barrier, use dangerous chemicals, or attach to an outside surface of the riser.

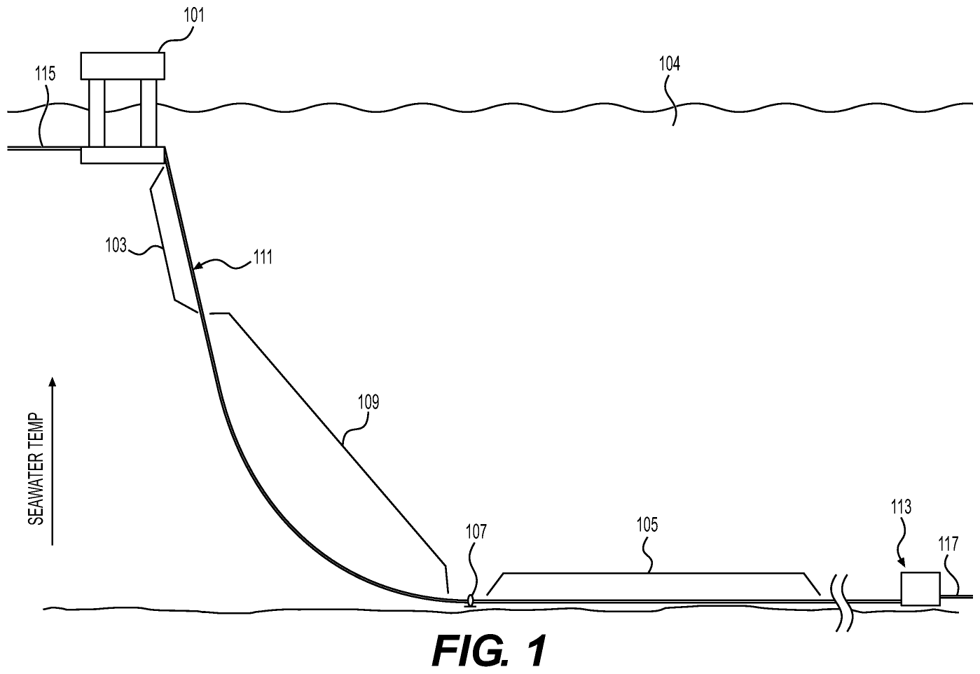

FIG. 1 depicts a system for transporting fluid or gas via a conduit, in accordance with some embodiments. In particular, FIG. 1 depicts a subsea oil and gas system. In an embodiment, the system may comprise one or more conduits, more specifically one or more first subsea pipelines 111 (e.g., a flowline), that may be used to transport materials (e.g., crude oil, natural gas, water) from a reservoir (not shown) to an offshore platform 101. The offshore platform 101 may comprise a floating, or above-water portion of any type of floating production system, including, as non-limiting examples, floating production storage and offloading (FPSO) system, floating storage and offloading (FSO) system, tension leg platforms (TLPs), or combinations thereof. The offshore platform 101 may be used to divide the contents of the reservoir into separate quantities of crude oil, natural gas, and water. The offshore platform may export these contents to land (not shown) via or more second subsea pipelines 115 (e.g., an export pipeline). For example, the one or more additional subsea pipelines 115 may carry natural gas and crude oil to locations where it can be processed into fuels such as gasoline.

In an embodiment, a first subsea pipeline 111 may receive the contents from a subsea manifold 113. The subsea manifold may be connected to one or more wells (not shown) via one or more third subsea pipelines 117. The one or more wells may, in turn, be configured to retrieve materials such as crude oil and/or natural gas from a subsea reservoir. These contents may be passed along to the subsea manifold which may be configured to collect the contents from the one or more wells and distribute the contents to the offshore platform 101 via the first subsea pipeline 111.

The first subsea pipeline 111 may comprise a lower portion 105, an intermediate portion 109, and an upper portion 103. The lower portion may be a horizontal portion which is disposed along the seafloor. The intermediate portion 109 and upper portion 103 may, together, make up a riser portion that connects to the offshore platform 101. The first subsea pipeline 111 may further comprise a touch-down point 107 at the interface between the riser and the lower portion 105.

In an embodiment, the components of the system described above may be submerged and/or floating in seawater 104. Along the seafloor, proximate to lower portion 105, a temperature of the seawater 104 may be relatively constant (e.g., about 4 degrees Celsius). The temperature of the seawater 104 may be greater at shallower depths, as indicated by the arrow shown in FIG. 1. The low, constant temperature of the seawater 104 near the seafloor may contribute to the accumulation of buildup, such as wax and hydrates, within the first subsea pipeline 111.

In particular, the intermediate region 109 may be at risk of buildup. Fluid moving through this region is at its coldest, as it enters the intermediate region 109 after traversing through the entire lower portion 105, and a difference in hydrostatic pressure within intermediate region 109 may cause additional Joule-Thompson cooling. Further, region 109 may be highly insulated and covered by vortex shedding devices making it hard to access and heat from the outside. Any accumulation of buildup may slow the flow of fluid through the pipeline and negatively impact performance of the system. Accordingly, embodiments described herein comprise solutions for reducing buildup in this intermediate region 109 without requiring access from the outside.

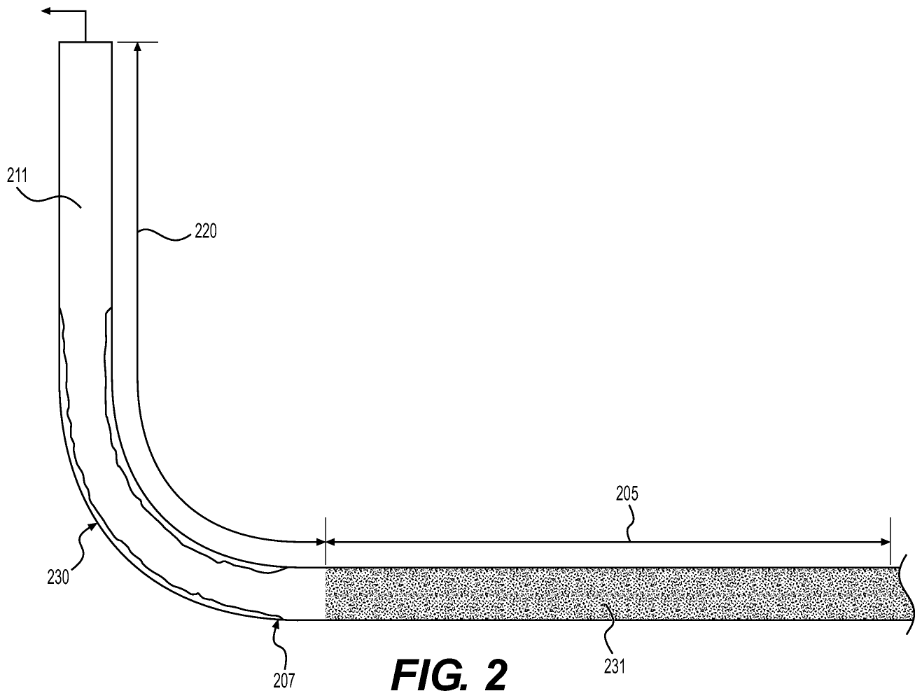

In an embodiment, this solution may comprise applying a heating mechanism along the lower portion 105. In doing so, the contents flowing through the pipeline may avoid the cooling phenomenon that results in low temperature material entering the bottom of the riser and within intermediate portion 109. Such a solution is described in greater detail below with respect to FIG. 2.

FIG. 2 is a diagram depicting an example system for clearing buildup from a conduit, in accordance with some embodiments. The system may comprise a conduit 211 (e.g., a flowline) having a lower portion 205 and a riser 220 separated by a touch-down point 207 where the riser 220 meets the ground. In an embodiment, the conduit 211 may comprise a first subsea pipeline 111 as described above with respect to FIG. 1. As described above, the conduit 211 may be configured to supply contents such as crude oil, natural gas, and/or water from a subsea manifold or well to an offshore platform. Due to environmental factors, buildup 230 may accumulate on sidewalls of the riser portion 220. In order to clear this buildup, a heating mechanism 231 may be applied to a section of the lower portion 205.

For example, in a subsea system, buildup 230 may be caused at least in part by the low temperature of contents entering the riser portion 220 from the lower portion 205. This effect may be avoided by applying heating mechanism 231 to a section of the lower portion 205. The heating mechanism may be configured to heat a corresponding portion of the conduit 211 to an elevated temperature. In some cases, the elevated temperature may be greater than approximately 26 degrees Celsius, or in other cases, may be greater than approximately 50 degrees Celsius. As described above, the temperature near the seafloor may be approximately 4 degrees Celsius, and thus the heating mechanism 231 may provide a heating increase having a ratio of temperature after heating to temperature before heating of greater than approximately 6.5:1, or in some cases, greater than approximately 12.5:1.

In some embodiments, flow through the conduit 211 may be restricted while the heating mechanism 231 is heating up that section of the flowline. Once heated to a sufficient level, flow may be introduced into the lower portion 205 of the conduit 211, through the portion that was heated by the heating mechanism 231. This flow may move the heated fluid and/or gas from the section of the lower portion where heating mechanism 231 was applied and into the riser section 220 in order to dissolve the buildup 230. Flow may then be continued at a constrained rate so that the heater may raise passing contents to a base maintenance temperature until the buildup 230 is cleared.

It is noted that while examples above describe a subsea system, this mechanism may be applied in any conduit-based transport system where fluid/gas is moved through a riser section. By heating the fluid/gas before it enters the riser, any buildup present within the riser section may be dissolved by the heated contents passing therethrough.

In accordance with some embodiments, the heating mechanism 231 may comprise either a temporary heater or a permanently installed heater. In embodiments comprising a subsea system and a temporarily installed heater, a subsea flowline remediation heating system may be utilized, for example as described in U.S. patent application Ser. No. 18/124,020, the entirety of which is incorporated herein by reference. In other embodiments, a permanent heating system may be installed on the lower portion of the flowline, for example with insulation and/or soil cover.

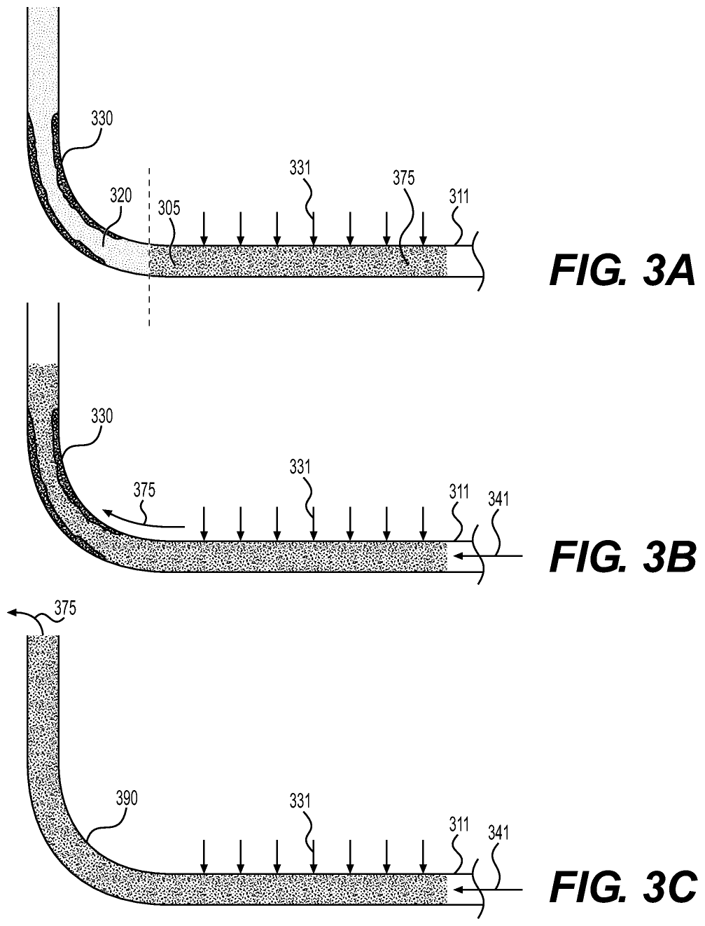

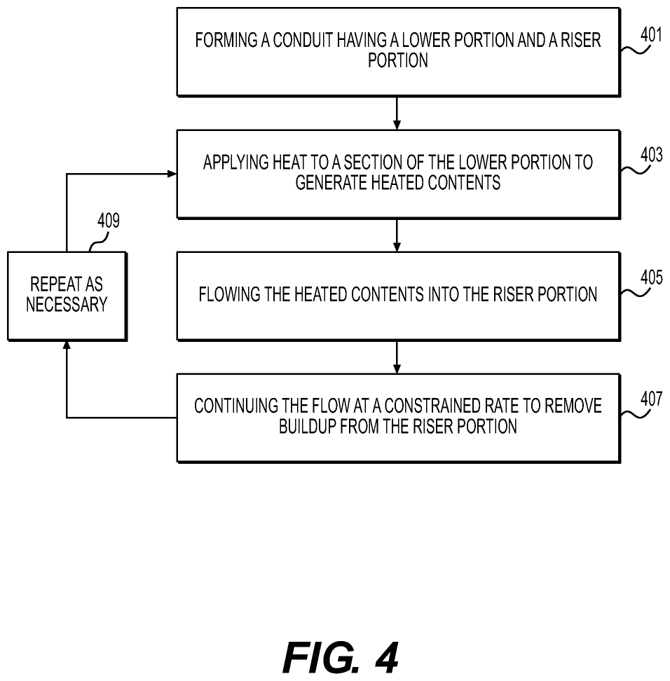

FIGS. 3A, 3B, and 3C depict a method for clearing buildup from a conduit riser section in accordance with some embodiments. FIG. 4 is a flowchart depicting the method shown with respect to FIGS. 3A, 3B, and 3C. In the description that follows, reference is made to FIG. 4 along with the corresponding components depicted in FIGS. 3A, 3B, and 3C.

In an embodiment, and as shown at 401, the method may comprise forming a conduit comprising a lower portion and a riser. As shown in FIG. 3A, this may comprise forming conduit 311 comprising a lower portion 305 and a riser 320. The conduit 311 may, for example, be a flowline of a subsea oil and gas system and may transport contents (e.g., crude oil, natural gas, and water) from a subsea manifold on the sea floor to an offshore platform. Due to certain environmental conditions, such as a temperature of the seawater, buildup 330 may accumulate in the riser portion 320 of the conduit 311. This buildup may constrict the flow of fluid and/or gas through the conduit.

To remove this buildup, the method may further comprises heating a section of the lower portion of the conduit, as shown at 403. In an embodiment, and as shown in FIG. 3A, heat 331 is applied to a section of the lower portion 305 of conduit 311. This heat may be supplied via a heating mechanism such as, for example, a temporary heater or a permanently installed heater. As described above with reference to FIG. 2, an example temporary heater may comprise a subsea flowline remediation heating system. Applying heat 331 to the section of the lower portion may generate heated contents 375 within that section of the lower portion. The heated contents may reach a temperature that is 6.5 or more times greater, or in some cases, 12.5 or more times greater than the pre-heated temperature of contents within the conduit.

In some embodiments, prior to applying heat, flow through the conduit may be restricted such that heat is applied to a relatively stationary area of fluid/gas and raise its temperature. This may generate a section of hot fluid/gas, meaning it has reached a temperature sufficient to break down buildup through the conduit. Once a sufficient temperature has been reached, the method may proceed to 405 where the heated contents 375 may be moved from the lower portion 305 into the riser portion 320. For example, where the conduit 311 is a subsea pipeline, the pipeline may be configured to transmit crude oil, natural gas, and/or water from a subsea manifold or subsea well to an offshore platform. Prior to applying heat, a flow from the subsea manifold or subsea well may be turned off to create a relatively stationary portion of crude oil, natural gas, and/or water in a position corresponding with the heat application.

As shown in FIG. 3B, flow may then be opened up through the lower portion of conduit 311, indicated by arrow 341. This flow may cause the heated contents 375 to move up into the riser portion of the conduit 311 and through the area comprising buildup 330. Over time, the buildup 330 may be removed by flowing the heated contents 375 through the buildup 330. For example, the heated contents 375 may comprise a hot fluid of crude oil, natural gas, and/or water that may remove buildup, such as, for example hydrate or wax buildup, from the pipeline walls when flowed through the buildup.

As shown in FIG. 3C and described at 407, after the heated contents begin to flow into the riser of conduit 311 and through the buildup 330, the method may further comprise continuing to apply heat 331 to the section of the lower portion of the conduit 311 and continuing the flow 341 through the conduit. In an embodiment, the flow 341 may continue at a constrained rate so that the applied heat 331 can raise passing fluid to a base maintenance temperature until the buildup is cleared from the riser portion. The heated contents 375 may remove buildup from the conduit 311 while flowing, thereby resulting in clean sidewalls 390.

In some embodiments, once the buildup is cleared from the conduit, the heat may be removed from the section of the lower portion of the conduit. This may save power and costs associated with continuously running a heating mechanism. If buildup accumulates again after removing the heat, the process may be repeated as necessary as shown at 409.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

It is claimed:

1. A buildup removal system comprising:
a conduit for transporting contents, wherein the conduit comprises a lower portion and a riser portion; and
a heating mechanism configured to apply heat to a section of the lower portion and generate heated contents within the conduit,
wherein the heated contents comprise a temperature that removes buildup from sidewalls of the riser portion.

2. The system of claim 1, wherein the conduit comprises a subsea pipeline and the contents comprise crude oil, natural gas, and/or water.

3. The system of claim 2, wherein the lower portion is disposed along a seafloor.

4. The system of claim 3, further comprising a subsea manifold configured to supply the contents to the lower portion of the subsea pipeline and an offshore platform configured to receive the contents from the riser portion of the subsea pipeline.

5. The system of claim 1, wherein the buildup comprises at least one of a wax buildup and a hydrate buildup.

6. The system of claim 1, wherein the heating mechanism comprises one of a temporary heater or a permanently installed heater.

7. The system of claim 1, wherein the riser portion comprises an upper portion and an intermediate portion; and
the buildup is disposed on sidewalls of the intermediate portion of the riser.

8. The system of claim 1, wherein the heating mechanism is configured to supply heat to the contents such that the temperature of the heated contents is greater than 6.5 times a temperature of the contents without the supplied heat.

9. A method of clearing buildup from a conduit comprising a lower portion and a riser portion comprising:
applying heat to a section of the lower portion to generate heated contents within the section of the lower portion of the conduit; and
flowing the heated contents into the riser portion such that the heated contents remove buildup from sidewalls of the riser portion.

10. The method of claim 9, wherein the heat is applied via a heating mechanism comprising one of a temporary heater or a permanently installed heater.

11. The method of claim 9, further comprising continuing a flow the through the conduit at a constrained rate.

12. The method of claim 9, wherein prior to applying heat, a flow through the conduit is restricted.

13. The method of claim 9, wherein the conduit comprises a subsea pipeline and the buildup comprises wax and/or hydrate buildup.

14. The method of claim 13, wherein the lower portion is disposed along a seafloor and configured to receive input contents from a subsea manifold; and
the input contents comprise crude oil, natural gas, and/or water.

15. The method of claim 14, wherein the process of applying heat generates the heated contents from the input contents.

16. The method claim 15, wherein the input contents comprise a first temperature and the heated contents comprise a second temperature that is 6.5 times or more greater than the first temperature.

17. The method of claim 14, wherein the riser portion is configured to supply the heated contents to an offshore platform.

18. The method of claim 15, wherein the offshore platform is configured to divide the heated contents into separate quantities of crude oil, natural gas, and water.

19. A subsea oil and gas system comprising:
an offshore platform;
a subsea manifold;
a first subsea pipeline comprising a horizontal lower portion disposed along a seafloor and a riser portion extending vertically from the horizontal lower portion; and
a heating mechanism,
wherein the offshore platform is configured to:
receive contents from the first subsea pipeline, wherein the contents comprise crude oil, natural gas, and water,
divide the contents into separate quantities of crude oil, natural gas and water; and
export the separate quantities to land via a second subsea pipeline;
the subsea manifold is configured to receive the contents from a third subsea pipeline and supply the contents to the horizontal lower portion of the first subsea pipeline; and
the heating mechanism is configured to apply heat to the contents within the first subsea pipeline such that the contents remove a buildup from sidewalls of the riser portion.

20. The system of claim 19, wherein the buildup comprises a wax and/or hydrate buildup.
